(19) United States
(12) Patent Application Publication
(10) Pub. No.: US 2026/0303241 A1
(43) Pub. Date: Oct. 1, 2026

(54) Wireless communication method and device for transmission rate adaptation using a prediction model

(71) Applicant: MEDIATEK INC., Hsinchu City (TW)

(72) Inventors: Yu-Hong Cheng, Hsinchu City (TW); Po-Chi Chen, Hsinchu City (TW); Chien-Hsuan Wu, Hsinchu City (TW); Bo-Yu Huang, Hsinchu City (TW)

(73) Assignee: MEDIATEK INC., Hsinchu City (TW)

(21) Appl. No.: 19/575,942

(22) Filed: Mar. 24, 2026

Related U.S. Application Data
(60) Provisional application No. 63/781,381, filed on Apr. 1, 2025.

(51) Int. Cl. H04B 17/373

(52) U.S. Cl. CPC H04B 17/373

(57) ABSTRACT

Methods and wireless communication devices for rate adaptation in wireless networks are disclosed. In one aspect, a wireless communication device obtains channel condition information associated with a wireless channel and applies a prediction model to the channel condition information to generate transmission quality predictions for candidate transmission rates. The device selects a target transmission rate based on the predictions and transmits data packets at the target transmission rate. In another aspect, the prediction model determines a predicted maximum usable transmission rate for a selected channel bandwidth. A reduced transmission rate is lower than the predicted maximum usable transmission rate by a predetermined rate offset, and the device switches to a narrower channel bandwidth when the target transmission rate reaches the reduced transmission rate. In yet another aspect, model parameters of the prediction model are adjustable based on actual transmission results.

### CROSS REFERENCE TO RELATED APPLICATIONS

This application claims the benefit of U.S. Provisional Application No. 63/781,381, filed on Apr. 1st, 2025. The content of the application is incorporated herein by reference.

### BACKGROUND

Wireless communication devices may use rate adaptation (RA) to change a transmission rate when channel conditions change. In some RA approaches, a device may try different transmission rates, one by one, by sending test packets and checking the results. This process is sometimes called rate probing. When channel conditions become worse, the device may need to try several lower rates before it finds a rate that works well. When channel conditions become better, the device may try higher rates, and may try a rate that is too high for the channel to support. This may cause packet loss. The device may then need to drop back to a lower rate. This probing process may take time, use extra power, and interrupt data transmission.

In wireless networks that support more than one channel bandwidth, a device may need to move from a wider bandwidth to a narrower bandwidth when interference is present on some frequency ranges. In some approaches, the device may keep using the wider bandwidth until the transmission rate has fallen to a very low level. As a result, the device may spend a long time sending data at a poor rate before it switches to the narrower bandwidth. During this time, packets may be lost and transmission delay may grow.

### SUMMARY

An embodiment of the present disclosure provides a method for wireless communication performed by a wireless communication device. The method comprises obtaining channel condition information associated with a wireless channel; applying a prediction model to the channel condition information to generate transmission quality predictions for one or more candidate transmission rates; selecting a target transmission rate from the one or more candidate transmission rates based on the transmission quality predictions; and transmitting one or more data packets at the target transmission rate.

Another embodiment of the present disclosure provides a method for wireless communication performed by a wireless communication device. The method comprises obtaining channel condition information associated with a wireless channel for a selected channel bandwidth; applying a prediction model to the channel condition information to determine a predicted maximum usable transmission rate for the selected channel bandwidth; determining a reduced transmission rate that is lower than the predicted maximum usable transmission rate by a predetermined rate offset; selecting a target transmission rate that is less than or equal to the predicted maximum usable transmission rate and greater than or equal to the reduced transmission rate; and transmitting one or more data packets at the target transmission rate.

Another embodiment of the present disclosure provides a wireless communication device. The wireless communication device comprises at least one processor, a transceiver, and a memory. The memory stores instructions that, when executed by the at least one processor, cause the wireless communication device to obtain channel condition information associated with a wireless channel. When executed by the at least one processor, the instructions further cause the wireless communication device to apply a prediction model to the channel condition information to generate transmission quality predictions for one or more candidate transmission rates. When executed by the at least one processor, the instructions further cause the wireless communication device to select a target transmission rate from the one or more candidate transmission rates based on the transmission quality predictions, and to control the transceiver to transmit one or more data packets at the target transmission rate.

Another embodiment of the present disclosure provides a wireless communication device. The wireless communication device comprises at least one processor, a transceiver, and a memory. The memory stores instructions that, when executed by the at least one processor, cause the wireless communication device to obtain channel condition information associated with a wireless channel for a selected channel bandwidth. When executed by the at least one processor, the instructions further cause the wireless communication device to apply a prediction model to the channel condition information to determine a predicted maximum usable transmission rate for the selected channel bandwidth. When executed by the at least one processor, the instructions further cause the wireless communication device to determine a reduced transmission rate that is lower than the predicted maximum usable transmission rate by a predetermined rate offset. When executed by the at least one processor, the instructions further cause the wireless communication device to select a target transmission rate that is less than or equal to the predicted maximum usable transmission rate and greater than or equal to the reduced transmission rate, and to control the transceiver to transmit one or more data packets at the target transmission rate.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a wireless communication device according to an embodiment of the present disclosure.

FIG. 2 is a diagram illustrating rate-down adaptation of the wireless communication device in FIG. 1 according to some implementations of the present disclosure.

FIG. 3 is a diagram illustrating rate-up adaptation of the wireless communication device in FIG. 1 according to some implementations of the present disclosure.

FIG. 4 is a diagram illustrating spatial stream selection of the wireless communication device in FIG. 1 according to some implementations of the present disclosure.

FIG. 5 is a diagram illustrating bandwidth adaptation of the wireless communication device in FIG. 1 according to some implementations of the present disclosure.

FIG. 6 is a block diagram of a functional module architecture of the wireless communication device in FIG. 1 according to an embodiment of the present disclosure.

FIG. 7 is a flowchart of a method for wireless communication performed by the wireless communication device in FIG. 1 according to an embodiment of the present disclosure.

FIG. 8 is a schematic diagram illustrating an off-line learning process for a prediction model according to an embodiment of the present disclosure.

FIG. 9 is a schematic diagram illustrating an on-line learning process for the prediction model of the wireless communication device in FIG. 1 according to an embodiment of the present disclosure.

FIG. 10 is a diagram illustrating an effect of on-line calibration on rate selection according to an embodiment of the present disclosure.

FIG. 11 is a diagram illustrating rate down brakes with bandwidth reduction of the wireless communication device in FIG. 1 according to some implementations of the present disclosure.

### DETAILED DESCRIPTION

The following description sets forth exemplary embodiments and does not limit the scope of the appended claims. Features described in connection with one embodiment may be combined with features of other embodiments. Reference throughout this specification to "one embodiment," "an embodiment," "certain embodiments," or similar language means that a particular feature, structure, or characteristic described in connection with the embodiment may be included in at least one embodiment.

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details.

As used herein, the term "prediction model" refers to a machine learning model that has been trained to receive input data and generate predictions as output. The prediction model includes model parameters that are determined during training and may be further adjusted during operation (on-line learning). The prediction model is not limited to any particular neural network architecture.

As used herein, the term "channel condition information" refers to information that characterizes the state of a wireless channel. Channel condition information may include, but is not limited to, a received signal strength indicator (RSSI), a signal-to-noise ratio (SNR), a packet error rate (PER), an interference indicator, a distance between devices, traffic information, and an angle indicator. Channel condition information may change over time as the wireless environment changes.

As used herein, the term "transmission quality prediction" refers to an output of the prediction model that indicates a predicted transmission quality for a given candidate transmission rate. A transmission quality prediction may indicate, for example, whether a candidate transmission rate is predicted to be usable or unusable under the current channel conditions.

As used herein, the term "candidate transmission rate" refers to a transmission rate that the wireless communication device may evaluate for use in transmitting data packets. One or more candidate transmission rates may be provided as input to the prediction model.

As used herein, the term "target transmission rate" refers to the transmission rate that the wireless communication device selects for transmitting one or more data packets. The target transmission rate is selected from among the one or more candidate transmission rates based on the transmission quality predictions.

As used herein, the term "model parameters" refers to the trainable weight values of the prediction model. The model parameters may be adjusted during off-line training, during on-line learning, or both.

As used herein, the term "actual transmission result" refers to feedback obtained after the wireless communication device transmits one or more data packets. The actual transmission result may include, for example, an acknowledgement (ACK) or a negative acknowledgement (NACK) received from the peer device.

As used herein, the term "prediction accuracy" refers to a metric that indicates how well the transmission quality predictions of the prediction model match the actual transmission results. The prediction accuracy may be determined based on a comparison between the transmission quality predictions and the actual transmission results over a period of recent transmissions.

As used herein, the term "predetermined rate offset" refers to a fixed difference in rate levels between a predicted maximum usable transmission rate and a reduced transmission rate for a given channel bandwidth. The predetermined rate offset defines the width of a rate operating range for each channel bandwidth.

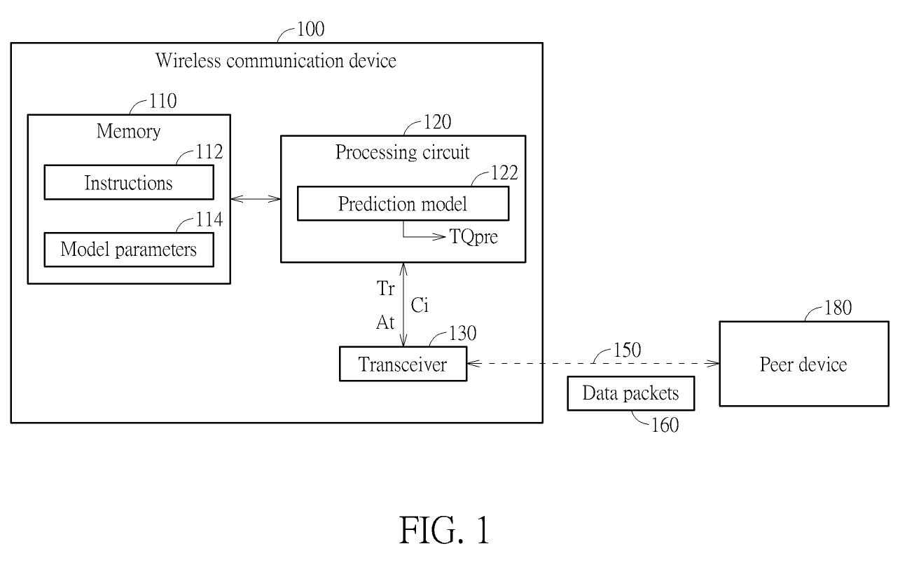

FIG. 1 illustrates a wireless communication device 100 according to an embodiment of the present disclosure. The wireless communication device 100 may be implemented as an access point (AP), an AP client, or a station (STA) in a wireless network. An AP client is a device that connects to a wireless network through an AP and simultaneously allows other devices to connect through it, effectively operating as both a client of the AP and a local access point for downstream devices. In some embodiments, the wireless communication device 100 communicates with a peer device 180 over a wireless channel 150. The peer device 180 may be an AP, an AP client, a STA, or any other wireless device that is capable of exchanging wireless signals with the wireless communication device 100. The wireless communication device 100 and the peer device 180 may communicate using any suitable wireless communication protocol, including, but not limited to, Wi-Fi^{®} (for example, IEEE 802.11a/b/g/n/ac/ax/be), Bluetooth^{®}, Bluetooth Low Energy (BLE), Zigbee^{®}, Z-Wave^{®}, or a cellular protocol such as Long-Term Evolution (LTE) or New Radio (NR). In certain embodiments, the wireless communication device 100 supports more than one wireless communication protocol.

As shown in FIG. 1, the wireless communication device 100 comprises a memory 110, a processing circuit 120, and a transceiver 130. The memory 110 is coupled to the processing circuit 120, and the processing circuit 120 is coupled to the transceiver 130. Each of these components is described below.

The memory 110 stores data and program code used by the processing circuit 120. In the embodiment of FIG. 1, the memory 110 stores instructions 112 and model parameters 114.

The memory 110 may include one or more of the following types of storage: volatile memory such as random-access memory (RAM), static RAM (SRAM), or dynamic RAM (DRAM); non-volatile memory such as read-only memory (ROM), flash memory, or electrically erasable programmable ROM (EEPROM); or a combination of volatile and non-volatile memory. In certain embodiments, the memory 110 may be implemented on the same integrated circuit as the processing circuit 120, for example as on-chip SRAM. In other embodiments, the memory 110 may be a separate memory chip coupled to the processing circuit 120 through a memory bus. In some implementations, a portion of the memory 110 may reside on-chip while another portion resides off-chip. For example, the instructions 112 may be stored in an on-chip ROM or flash memory, while the model parameters 114 may be stored in on-chip SRAM that allows fast read and write access during operation.

The instructions 112 are program code stored in the memory 110. When the processing circuit 120 reads and executes the instructions 112, the processing circuit 120 performs the methods described in the present disclosure. For example, the instructions 112 may include program code that causes the processing circuit 120 to obtain channel condition information from the transceiver 130, to apply a prediction model 122 to the channel condition information, to select a target transmission rate based on transmission quality predictions generated by the prediction model 122, and to control the transceiver 130 to transmit data packets 160 at the target transmission rate. The instructions 112 may be stored as firmware that is loaded into the memory 110 during manufacturing, or the instructions 112 may be updated through a firmware update after deployment.

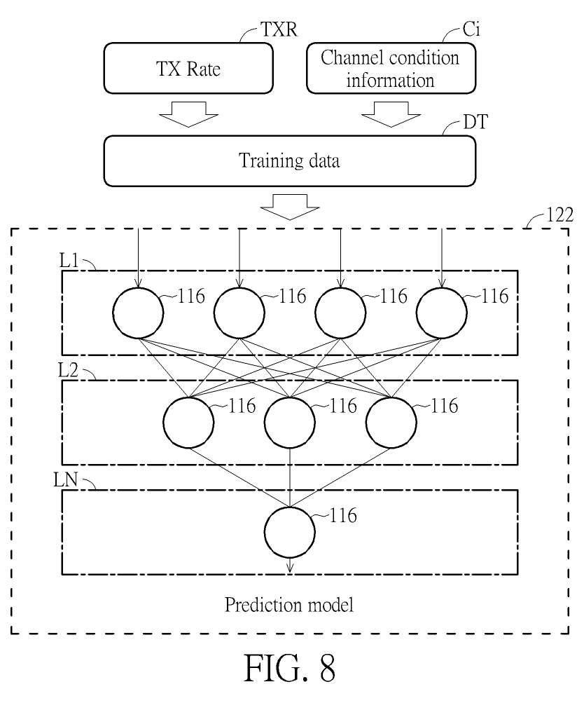

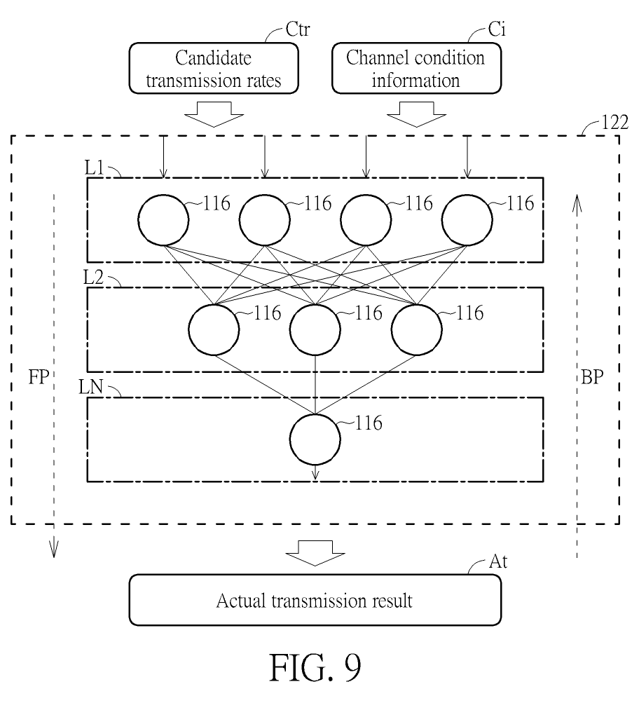

The model parameters 114 are stored in the memory 110 and represent the trainable weight values of the prediction model 122. The model parameters 114 may include, for example, weight coefficients and bias values associated with one or more layers of a neural network. As shown in FIG. 1, a bidirectional arrow connects the memory 110 to the processing circuit 120, indicating that the processing circuit 120 may read data from the memory 110 and may write data back to the memory 110. Through this bidirectional connection, the prediction model 122 in the processing circuit 120 may access the model parameters 114 stored in the memory 110 during inference, and may store updated model parameters 114 back to the memory 110 during on-line learning. The off-line training and the on-line updating of the model parameters 114 are described in further detail with reference to FIG. 8 and FIG. 9, respectively.

The processing circuit 120 reads and executes the instructions 112 stored in the memory 110 to perform the operations described in the present disclosure. The processing circuit 120 may include one or more processors, such as a central processing unit (CPU), a digital signal processor (DSP), a microcontroller unit (MCU), or a combination of these. In some embodiments, the processing circuit 120 may include a dedicated hardware accelerator, such as a neural processing unit (NPU), configured to accelerate inference operations performed by the prediction model 122. In other embodiments, the processing circuit 120 may be a general-purpose processor that executes the prediction model 122 in software. The processing circuit 120 may be implemented as a single integrated circuit, or as multiple processors operating together within the wireless communication device 100.

As shown in FIG. 1, the prediction model 122 receives channel condition information Ci and generates transmission quality predictions TQpre for one or more candidate transmission rates. Based on the transmission quality predictions TQpre, the processing circuit 120 selects a target transmission rate Tr and controls the transceiver 130 to transmit data packets 160 at the target transmission rate Tr.

In certain embodiments, the prediction model 122 is implemented as a neural network comprising one or more hidden layers. The internal structure of the neural network is described in further detail with reference to FIG. 8 and FIG. 9. The transmission quality predictions TQpre may indicate, for each candidate transmission rate, whether the candidate transmission rate is predicted to be usable or unusable under the current channel conditions.

During inference, the processing circuit 120 reads the model parameters 114 from the memory 110 to compute the transmission quality predictions TQpre. During on-line learning, the processing circuit 120 updates the model parameters 114 based on actual transmission results, as described in further detail with reference to FIG. 9.

The transceiver 130 is a wireless communication interface that transmits and receives wireless signals through the wireless channel 150. The transceiver 130 may include a transmitter, a receiver, or both. In some embodiments, the transceiver 130 comprises one or more radio frequency (RF) chains, one or more antennas, a baseband processor, a medium access control (MAC) layer processor, and related analog and digital circuitry. In other embodiments, the transceiver 130 may share the baseband processor or the MAC layer processor with the processing circuit 120. The transceiver 130 may support one or more of the wireless communication protocols described above.

As shown in FIG. 1, the transceiver 130 exchanges information with the processing circuit 120. The information exchanged between the transceiver 130 and the processing circuit 120 may include, for example, channel condition information Ci, the target transmission rate Tr, and an actual transmission result At.

The channel condition information Ci is provided from the transceiver 130 to the processing circuit 120. The channel condition information Ci comprises wireless channel state data collected by the transceiver 130, such as received signal strength indicator (RSSI), signal-to-noise ratio (SNR), packet error rate (PER), interference indicator, distance between the wireless communication device 100 and the peer device 180, traffic information indicating at least one of uplink traffic or downlink traffic, or angle indicator associated with at least one of an antenna orientation, an angle of arrival (AoA) of a received signal, or a beamforming direction. The packet error rate included in the channel condition information Ci is a statistical metric that characterizes the channel quality over a period of time. The packet error rate as a component of the channel condition information Ci is different from the actual transmission result At, which indicates the outcome of a specific transmission as described below. The channel condition information Ci serves as the input to the prediction model 122.

The processing circuit 120 controls the transceiver 130 based on the target transmission rate Tr. The processing circuit 120 may provide the target transmission rate Tr to the transceiver 130, or may directly configure the transmission parameters of the transceiver 130 based on the target transmission rate Tr. The transceiver 130 transmits one or more data packets 160 at the target transmission rate Tr through the wireless channel 150 to the peer device 180.

The actual transmission result At is provided from the transceiver 130 to the processing circuit 120 after the data packets 160 are transmitted. For example, the actual transmission result At may include an acknowledgement (ACK) or a negative acknowledgement (NACK) received from the peer device 180. The processing circuit 120 may use the actual transmission result At for on-line learning, as described in further detail with reference to FIG. 9.

The wireless channel 150 is a wireless communication medium between the wireless communication device 100 and the peer device 180. As shown in FIG. 1, the wireless channel 150 is represented by a dashed line connecting the transceiver 130 and the peer device 180. The wireless channel 150 may be subject to various conditions, including path loss, multipath fading, interference from other wireless devices, and noise. These conditions may change over time and may affect the transmission quality at different transmission rates.

The data packets 160 are transmitted by the transceiver 130 through the wireless channel 150 to the peer device 180. Each data packet of the data packets 160 is transmitted at the target transmission rate Tr that the processing circuit 120 has selected. In certain embodiments, the data packets 160 may carry user data such as audio, video, or application data. In other embodiments, the data packets 160 may carry control information.

The peer device 180 receives the data packets 160 from the transceiver 130 and sends back a response (for example, an ACK or NACK) through the wireless channel 150. The response from the peer device 180 is used by the transceiver 130 to generate the actual transmission result At that is fed back to the processing circuit 120.

In some embodiments, the wireless communication device 100 may include additional components not shown in FIG. 1, such as a power supply, a user interface, additional processors, or additional memory. FIG. 1 illustrates the components relevant to the transmission rate adaptation operations described in the present disclosure, and other components are omitted for clarity.

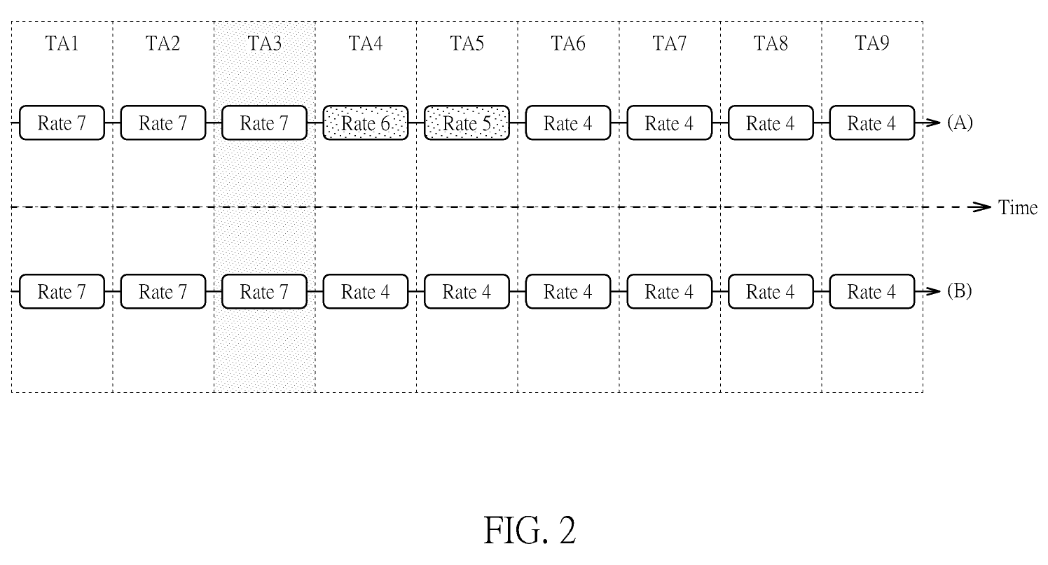

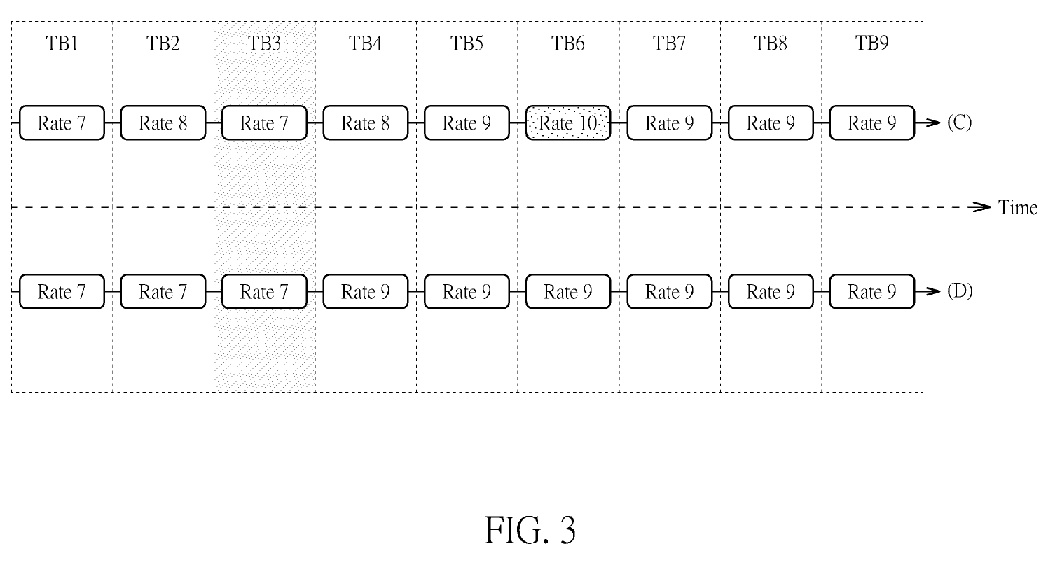

The wireless communication device 100 uses the prediction model 122 to select a target transmission rate based on transmission quality predictions TQpre. FIG. 2 and FIG. 3 illustrate how this rate selection operates in two common adaptation scenarios: a rate-down scenario where channel conditions worsen (FIG. 2), and a rate-up scenario where channel conditions improve (FIG. 3). Each figure compares two operational modes of the wireless communication device 100 side by side: one mode operates without the prediction model 122, and the other mode operates with the prediction model 122 enabled.

In FIG. 2 and FIG. 3, each rate is shown as a box with a solid border. A box with a white background means the rate is usable. A box with a patterned fill means the rate is unusable. A time slot with gray shading marks where a channel state change occurs. A higher rate level means higher data throughput. The rate levels and the number of time slots in FIG. 2 and FIG. 3 are examples for purposes of illustration.

FIG. 2 illustrates a rate-down adaptation scenario for the wireless communication device 100 according to some implementations of the present disclosure. The horizontal axis represents consecutive transmission time slots TA1 through TA9. The vertical axis represents transmission rate levels. FIG. 2 shows four rate levels as an example: Rate 7, Rate 6, Rate 5, and Rate 4, where Rate 7 is the highest and Rate 4 is the lowest.

In scenario (A), the wireless communication device 100 operates without the prediction model 122. The wireless communication device 100 transmits at Rate 7 during time slots TA1 through TA3. At time slot TA3, a channel state change occurs (shown as gray shading), and the channel conditions worsen.

Because the wireless communication device 100 does not have the prediction model 122 to predict which rates are usable under the changed channel conditions, the wireless communication device 100 probes lower rate levels one by one. At time slot TA4, the wireless communication device 100 attempts to transmit at Rate 6, which is unusable (shown with a patterned fill). At time slot TA5, the wireless communication device 100 attempts to transmit at Rate 5, which is also unusable (shown with a patterned fill). At time slot TA6, the wireless communication device 100 reaches Rate 4, which is usable, and continues to transmit at Rate 4 through time slot TA9.

In scenario (B), the wireless communication device 100 operates with the prediction model 122 enabled. The wireless communication device 100 likewise transmits at Rate 7 during time slots TA1 through TA3. At time slot TA3, the same channel state change occurs.

In response, the processing circuit 120 obtains updated channel condition information from the transceiver 130 and applies the prediction model 122 to the updated channel condition information to generate transmission quality predictions TQpre for the candidate transmission rates. Based on the transmission quality predictions TQpre, the prediction model 122 predicts that Rate 6 and Rate 5 are unusable and that Rate 4 is usable. At time slot TA4, the wireless communication device 100 directly selects Rate 4 as the target transmission rate, bypassing the transmission of test packets for Rate 6 and Rate 5. The wireless communication device 100 continues to transmit at Rate 4 during time slots TA4 through TA9.

Accordingly, in scenario (B), the wireless communication device 100 reaches the usable Rate 4 at time slot TA4, two time slots earlier than in scenario (A), and avoids two failed transmissions at Rate 6 and Rate 5.

FIG. 3 illustrates a rate-up adaptation scenario for the wireless communication device 100 according to some implementations of the present disclosure. The horizontal axis represents consecutive transmission time slots TB1 through TB9. FIG. 3 shows four rate levels: Rate 7, Rate 8, Rate 9, and Rate 10, where Rate 10 is the highest and Rate 7 is the lowest. FIG. 3 uses the same visual conventions as FIG. 2.

In scenario (C), the wireless communication device 100 operates without the prediction model 122. The wireless communication device 100 starts at Rate 7. At time slot TB2, the wireless communication device 100 probes Rate 8, but returns to Rate 7 at time slot TB3. At time slot TB3, a channel state change occurs and the channel conditions improve.

After the channel state change, the wireless communication device 100 probes higher rate levels one by one. The wireless communication device 100 probes Rate 8 at time slot TB4 and Rate 9 at time slot TB5, both of which are usable. At time slot TB6, the wireless communication device 100 probes Rate 10, which is unusable (shown with a patterned fill). The probe at Rate 10 fails, and the wireless communication device 100 reduces the transmission rate back to Rate 9 at time slot TB7. The wireless communication device 100 continues at Rate 9 through time slot TB9.

In scenario (D), the wireless communication device 100 operates with the prediction model 122 enabled. The wireless communication device 100 transmits at Rate 7 during time slots TB1 through TB3. At time slot TB3, the same channel state change occurs.

In response, the processing circuit 120 obtains updated channel condition information and applies the prediction model 122 to generate transmission quality predictions TQpre. Based on the transmission quality predictions TQpre, the prediction model 122 determines that Rate 9 is the predicted maximum usable transmission rate under the improved channel conditions, and that Rate 10 is unusable. At time slot TB4, the wireless communication device 100 directly selects Rate 9 as the target transmission rate, bypassing the transmission of test packets for Rate 10. The wireless communication device 100 continues to transmit at Rate 9 during time slots TB4 through TB9.

Accordingly, in scenario (D), the wireless communication device 100 reaches Rate 9 at time slot TB4, three time slots earlier than in scenario (C), and avoids the failed transmission at the unusable Rate 10.

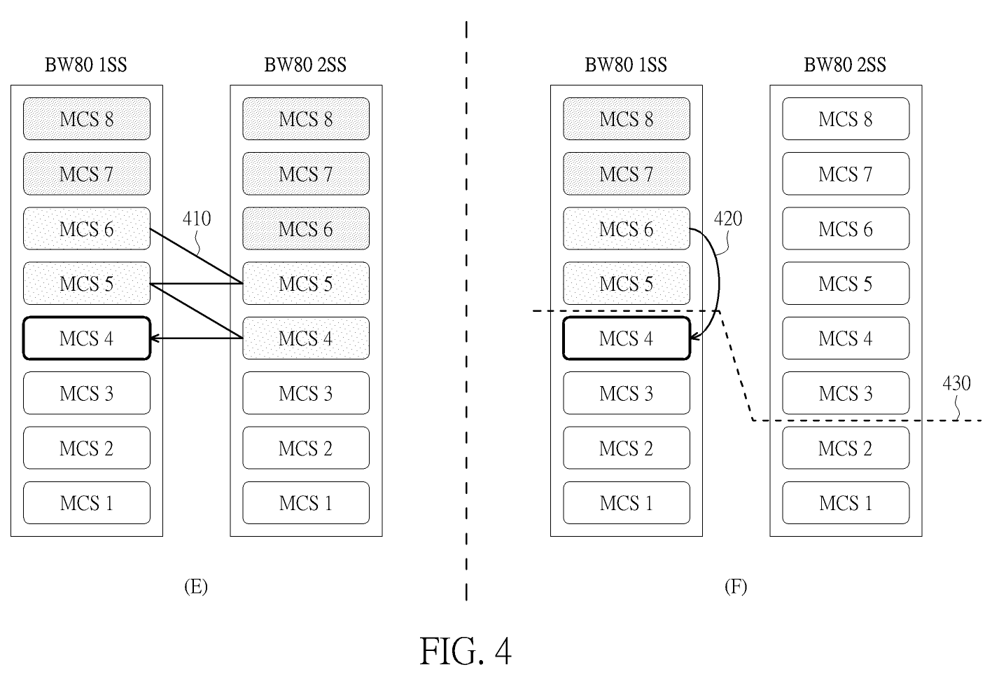

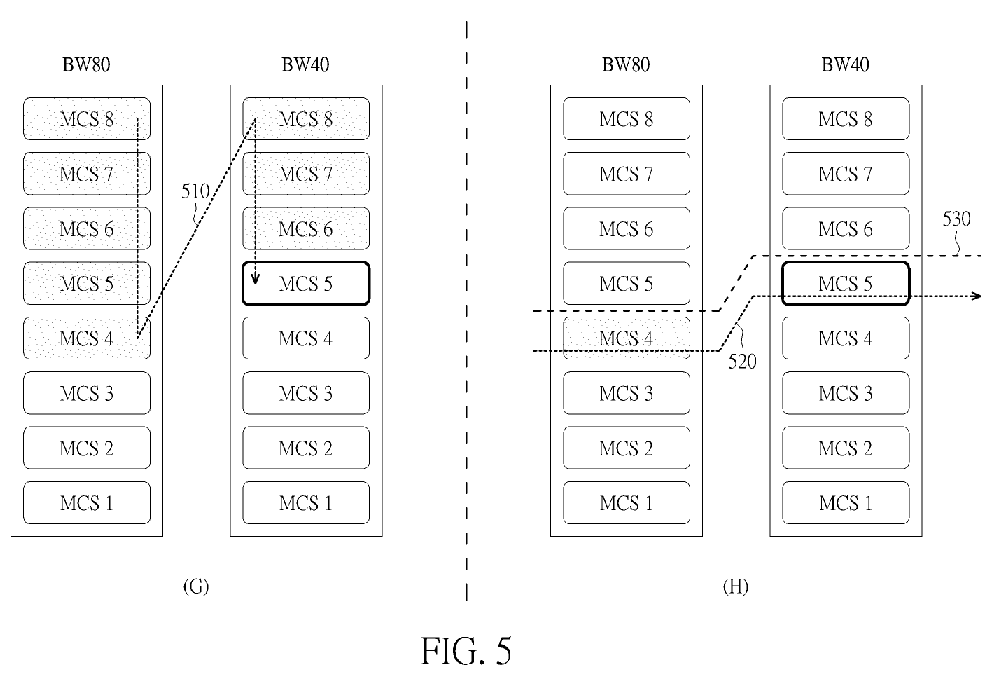

The rate-down and rate-up scenarios described with reference to FIG. 2 and FIG. 3 each involve rate adaptation within a single spatial stream configuration and a single channel bandwidth. FIG. 4 and FIG. 5 extend this rate adaptation to two additional dimensions. FIG. 4 illustrates how the wireless communication device 100 applies the prediction model 122 to select among different spatial stream configurations, and FIG. 5 illustrates how the wireless communication device 100 applies the prediction model 122 to select among different channel bandwidths. As with FIG. 2 and FIG. 3, each of FIG. 4 and FIG. 5 compares two operational modes side by side: one mode operates without the prediction model 122, and the other mode operates with the prediction model 122 enabled.

In FIG. 4 and FIG. 5, each rate is shown as a box representing a Modulation and Coding Scheme (MCS) level, where higher MCS levels correspond to higher data throughput. A box with a patterned fill indicates that the MCS rate is unusable under the current channel conditions. A box with a bold border marks the final selected target transmission rate. The MCS levels, the spatial stream configurations, and the channel bandwidths shown in FIG. 4 and FIG. 5 are examples for purposes of illustration.

FIG. 4 illustrates a spatial stream selection scenario for the wireless communication device 100 according to some implementations of the present disclosure. FIG. 4 shows two spatial stream configurations as an example: a single spatial stream configuration (labeled "BW80 1SS") and a dual spatial stream configuration (labeled "BW80 2SS"), both operating at an 80 MHz channel bandwidth. For each spatial stream configuration, FIG. 4 shows MCS rates from MCS 1 (lowest) to MCS 8 (highest).

A spatial stream is a data stream sent through one antenna of the transceiver 130. A "1SS" configuration uses one spatial stream, and a "2SS" configuration uses two spatial streams. Using more spatial streams can carry more data per transmission, but all participating antennas need to work well. If one antenna of the transceiver 130 works less effectively than another due to hardware variation or physical placement, the highest usable MCS rate may differ between the 1SS and 2SS configurations. The "BW80" in each label refers to an 80 MHz channel bandwidth. A wider channel bandwidth can carry more data but is more likely to be affected by interference.

In scenario (E), the wireless communication device 100 operates without the prediction model 122 and does not know the maximum usable MCS rate for each spatial stream configuration. In FIG. 4, several MCS rates in both the 1SS and 2SS columns have a patterned fill, indicating that these rates are unusable under the current channel conditions. In the 1SS column, MCS 8, MCS 7, MCS 6, and MCS 5 have a patterned fill. In the 2SS column, MCS 8, MCS 7, MCS 6, MCS 5, and MCS 4 have a patterned fill.

To find the best combination of spatial stream configuration and MCS rate, the wireless communication device 100 probes MCS rates across both the 1SS and 2SS configurations. A try rate path 410 in FIG. 4 illustrates this probing process. As shown by the try rate path 410, the wireless communication device 100 starts at MCS 6 in the 1SS configuration and crosses between the 1SS and 2SS configurations as it probes lower MCS rates. The try rate path 410 does not pass through every patterned-fill rate; for example, MCS 8 and MCS 7 in the 1SS column and MCS 8, MCS 7, and MCS 6 in the 2SS column are above the starting point of the try rate path 410 and are not probed. Along the try rate path 410, the wireless communication device 100 probes several rates that turn out to be unusable, including MCS 6 and MCS 5 in 1SS and MCS 5 and MCS 4 in 2SS. After probing through these unusable rates, the wireless communication device 100 settles on MCS 4 in the 1SS configuration (shown with a bold border). This cross-probing between 1SS and 2SS makes the try rate path 410 lengthy, and each failed attempt at an unusable rate wastes transmission time without delivering useful data.

In scenario (F), the wireless communication device 100 operates with the prediction model 122 enabled. The processing circuit 120 applies the prediction model 122 to the channel condition information to determine a maximum usable transmission rate for each of the plurality of spatial stream configurations. The maximum usable transmission rate is the highest MCS rate at which data can be successfully transmitted under the current channel conditions; MCS rates above it are too high for the channel to support and are therefore unusable. In the example of FIG. 4, the prediction model 122 determines that the maximum usable transmission rate for 1SS is MCS 4 (meaning MCS 5 and above are unusable for 1SS), and the maximum usable transmission rate for 2SS is MCS 2 (meaning MCS 3 and above are unusable for 2SS). A line 430 in FIG. 4 marks this predicted boundary for each spatial stream configuration. The line 430 separates the usable rates (at or below the boundary) from the unusable rates (above the boundary). In the 2SS column, the line 430 passes between MCS 3 and MCS 2, showing that MCS 2 is the highest rate that can be used for 2SS.

Because MCS 4 in 1SS is higher than MCS 2 in 2SS, the wireless communication device 100 selects the 1SS configuration as the spatial stream configuration having the highest maximum usable transmission rate among the plurality of spatial stream configurations. In scenario (F), MCS 8, MCS 7, MCS 6, and MCS 5 in the 1SS column are above the predicted maximum usable transmission rate and are therefore shown with a patterned fill. The 2SS column is not probed because the line 430 indicates that the 2SS configuration has a lower maximum usable transmission rate than the 1SS configuration. A try rate path 420 in FIG. 4 shows the resulting selection. The try rate path 420 stays within the 1SS column, skips the unusable MCS 8, MCS 7, MCS 6, and MCS 5, and goes directly to MCS 4 (shown with a bold border). Accordingly, in scenario (F), the wireless communication device 100 stays within the 1SS column and reaches MCS 4 directly with fewer failed transmissions than in scenario (E).

FIG. 5 illustrates a bandwidth adaptation scenario for the wireless communication device 100 according to some implementations of the present disclosure. FIG. 5 uses the same structure as FIG. 4. Instead of comparing spatial stream configurations, FIG. 5 compares two channel bandwidths: 80 MHz (labeled "BW80") and 40 MHz (labeled "BW40"). For each channel bandwidth, FIG. 5 shows MCS rates from MCS 1 (lowest) to MCS 8 (highest).

In scenario (G), the wireless communication device 100 operates without the prediction model 122. Interference affects the 80 MHz channel, causing MCS 8 through MCS 5 in the BW80 column to be unusable (shown with a patterned fill). The wireless communication device 100 probes these unusable rates one by one from higher to lower. A try rate path 510 in FIG. 5 shows this process. After probing far enough down in the BW80 column, the wireless communication device 100 crosses over to the BW40 column and settles on MCS 5 in BW40 (shown with a bold border). The try rate path 510 is lengthy because the wireless communication device 100 tries several unusable rates in BW80 before switching to BW40.

In scenario (H), the wireless communication device 100 operates with the prediction model 122 enabled. The processing circuit 120 applies the prediction model 122 to determine a maximum usable transmission rate for each of the plurality of channel bandwidths. In the example of FIG. 5, the prediction model 122 determines that the maximum usable transmission rate for BW80 is MCS 4 (meaning MCS 5 and above are unusable for BW80), and the maximum usable transmission rate for BW40 is MCS 5 (meaning MCS 6 and above are unusable for BW40). A line 530 in FIG. 5 marks the predicted boundary for each channel bandwidth, separating the usable rates from the unusable rates. The line 530 passes between MCS 5 and MCS 4 in the BW80 column, and between MCS 6 and MCS 5 in the BW40 column. The wireless communication device 100 compares the predicted maximum usable transmission rates across the channel bandwidths to decide which channel bandwidth to use.

Because the predicted maximum usable transmission rate for BW40 (MCS 5) is higher than the predicted maximum usable transmission rate for BW80 (MCS 4), the wireless communication device 100 selects BW40 based on a comparison of the maximum usable transmission rates. A try rate path 520 in FIG. 5 shows this result. The wireless communication device 100 moves from BW80 to BW40 and selects MCS 5 in BW40 as the target transmission rate (shown with a bold border). Accordingly, in scenario (H), the wireless communication device 100 switches to BW40 and selects MCS 5 with fewer failed transmissions than in scenario (G).

In some embodiments, the wireless communication device 100 may also use the same comparison to switch back from a narrower channel bandwidth to a wider channel bandwidth. For example, when the source of interference goes away, the predicted maximum usable transmission rate for BW80 may rise above the predicted maximum usable transmission rate for the currently selected BW40. The wireless communication device 100 may then switch from BW40 back to BW80.

In certain embodiments, the spatial stream selection described with reference to FIG. 4 and the bandwidth adaptation described with reference to FIG. 5 may be performed together. For example, after the processing circuit 120 determines the predicted maximum usable transmission rate for each spatial stream configuration as described with reference to FIG. 4, the processing circuit 120 may further determine the predicted maximum usable transmission rate for each channel bandwidth as described with reference to FIG. 5 to select the channel bandwidth and the spatial stream configuration for the next transmission.

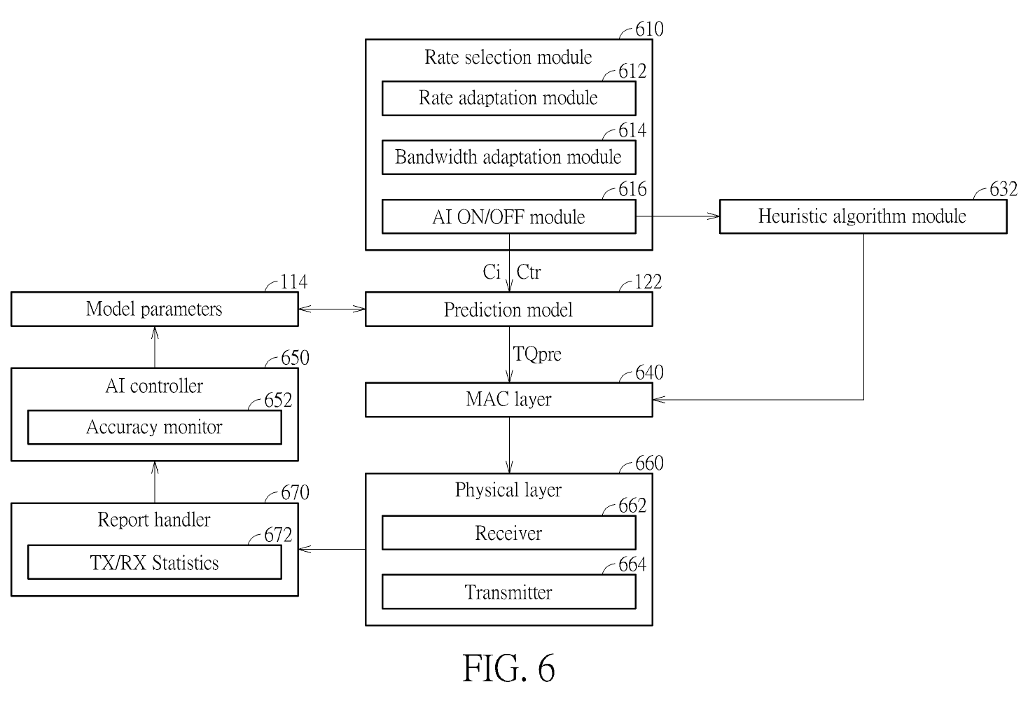

FIG. 1 described above shows the hardware components of the wireless communication device 100, including the memory 110, the processing circuit 120, and the transceiver 130. FIG. 6 illustrates the same wireless communication device 100 from a different angle. Instead of showing hardware components, FIG. 6 shows the functional modules that the hardware components of FIG. 1 implement together.

In the embodiment of FIG. 6, the processing circuit 120 executes the instructions 112 stored in the memory 110 to implement a rate selection module 610, the prediction model 122, a heuristic algorithm module 632, an AI controller 650, and a MAC layer 640. The model parameters 114 used by the prediction model 122 are stored in the memory 110, as described with reference to FIG. 1. A physical layer 660 shown in FIG. 6, including a receiver 662 and a transmitter 664, corresponds to the transceiver 130 described with reference to FIG. 1. A report handler 670 may be implemented by the processing circuit 120, by the transceiver 130, or by a combination of both.

The functional modules shown in FIG. 6 and their arrangement are examples for purposes of illustration. In other embodiments, the wireless communication device 100 may include fewer functional modules, additional functional modules, or a different arrangement of functional modules than shown in FIG. 6.

As shown in FIG. 6, the wireless communication device 100 includes the rate selection module 610. The rate selection module 610 is the decision layer that determines how the wireless communication device 100 selects a transmission rate and a channel bandwidth for each transmission. The rate selection module 610 includes a rate adaptation module 612, a bandwidth adaptation module 614, and an AI ON/OFF module 616.

The rate adaptation module 612 handles transmission rate adaptation decisions for the wireless communication device 100. For example, the rate adaptation module 612 may determine whether to increase or decrease the current transmission rate based on the channel conditions, as described with reference to FIG. 2 (rate-down adaptation) and FIG. 3 (rate-up adaptation). In some embodiments, the rate adaptation module 612 may use the transmission quality predictions from the prediction model 122 to identify which of the candidate transmission rates are predicted to be usable under the current channel conditions, and select the highest usable candidate transmission rate as the target transmission rate, as described with reference to FIG. 2 through FIG. 5.

The bandwidth adaptation module 614 handles channel bandwidth adaptation decisions for the wireless communication device 100. For example, the bandwidth adaptation module 614 may determine whether to switch from a wider channel bandwidth to a narrower channel bandwidth, or from a narrower channel bandwidth to a wider channel bandwidth, based on the channel conditions, as described with reference to FIG. 5. The bandwidth adaptation module 614 may also select a spatial stream configuration based on the channel conditions, as described with reference to FIG. 4.

The AI ON/OFF module 616 is a mode switch that controls whether the rate adaptation module 612 and the bandwidth adaptation module 614 use the prediction model 122 or the heuristic algorithm module 632 for their decisions.

When the AI ON/OFF module 616 is set to ON, the rate adaptation decisions and the bandwidth adaptation decisions are routed to the prediction model 122. As shown in FIG. 6, the prediction model 122 receives the channel condition information Ci and one or more candidate transmission rates Ctr as input, and generates transmission quality predictions TQpre as output. The rate selection module 610 then selects a target transmission rate Tr, a spatial stream configuration, and/or a channel bandwidth based on the transmission quality predictions TQpre.

When the AI ON/OFF module 616 is set to OFF, the rate adaptation decisions and the bandwidth adaptation decisions are routed to the heuristic algorithm module 632 instead. The AI ON/OFF module 616 may be set to OFF at startup before the prediction model 122 is available, or when the accuracy monitor 652 determines that the prediction accuracy of the prediction model 122 has fallen below an accuracy threshold, as described below.

The heuristic algorithm module 632 is a fallback path for the rate selection module 610. When the AI ON/OFF module 616 is set to OFF, the heuristic algorithm module 632 performs rate adaptation by probing candidate transmission rates one by one and observing the transmission results, as illustrated in scenarios (A), (C), (E), and (G) of FIG. 2 through FIG. 5.

As shown in FIG. 6, a bidirectional arrow connects the model parameters 114 to the prediction model 122. The model parameters 114 are read during forward propagation and updated during back propagation, as described with reference to FIG. 1 and FIG. 9.

The MAC layer 640 receives the selected target transmission rate Tr from the rate selection module 610. When the AI ON/OFF module 616 is set to ON, the target transmission rate Tr is determined by the transmission quality predictions TQpre from the prediction model 122. When the AI ON/OFF module 616 is set to OFF, the target transmission rate Tr is determined by the heuristic algorithm module 632. The MAC layer 640 then generates transmit packets according to the target transmission rate Tr and passes the transmit packets to the physical layer 660 for transmission.

The physical layer 660 corresponds to the transceiver 130 described with reference to FIG. 1. As shown in FIG. 6, the physical layer 660 comprises the receiver 662 and the transmitter 664. The transmitter 664 transmits the data packets 160 over the wireless channel 150 to the peer device 180 at the target transmission rate Tr. The receiver 662 receives wireless signals from the peer device 180, including, for example, acknowledgement (ACK) or negative acknowledgement (NACK) responses. In certain embodiments, the physical layer 660 may include additional components such as radio frequency (RF) chains, amplifiers, and analog-to-digital or digital-to-analog converters. These additional components are omitted from FIG. 6 for clarity.

The report handler 670 collects transmission and reception statistics from the physical layer 660. As shown in FIG. 6, the report handler 670 stores these statistics as TX/RX Statistics 672. The TX/RX Statistics 672 may include, for example, the number of packets transmitted, the number of packets that succeeded or failed, the transmission rate used for each packet, ACK or NACK responses from the peer device 180, and the time at which each packet was transmitted. The report handler 670 collects the TX/RX Statistics 672 regardless of whether the AI ON/OFF module 616 is set to ON or OFF.

The AI controller 650 monitors the performance of the prediction model 122. As shown in FIG. 6, the AI controller 650 comprises an accuracy monitor 652. The accuracy monitor 652 receives the TX/RX Statistics 672 from the report handler 670 and compares the transmission quality predictions TQpre generated by the prediction model 122 with the actual transmission results At recorded in the TX/RX Statistics 672. Based on this comparison, the accuracy monitor 652 determines a prediction accuracy of the prediction model 122. The prediction accuracy may be determined based on a comparison between the transmission quality predictions TQpre and the actual transmission results At over a period of recent transmissions.

When the prediction accuracy of the prediction model 122 is at or above an accuracy threshold, the accuracy monitor 652 does not take any corrective action, and the wireless communication device 100 continues to use the prediction model 122 for rate selection. When the prediction accuracy falls below the accuracy threshold, the accuracy monitor 652 triggers an adjustment of the model parameters 114. As shown in FIG. 6, a connection from the accuracy monitor 652 to the model parameters 114 indicates this on-line calibration path. The on-line calibration triggered by the accuracy monitor 652 may involve adjusting the model parameters 114 using back propagation based on the actual transmission results At, as described in further detail with reference to FIG. 9.

In some embodiments, when the prediction accuracy falls below the accuracy threshold, the accuracy monitor 652 may also signal the AI ON/OFF module 616 to switch from ON to OFF, so that the wireless communication device 100 temporarily uses the heuristic algorithm module 632 for rate selection while the model parameters 114 are being adjusted. After the model parameters 114 have been adjusted and the prediction accuracy returns to an acceptable level, the AI ON/OFF module 616 may be set back to ON so that the wireless communication device 100 resumes using the prediction model 122 for rate selection.

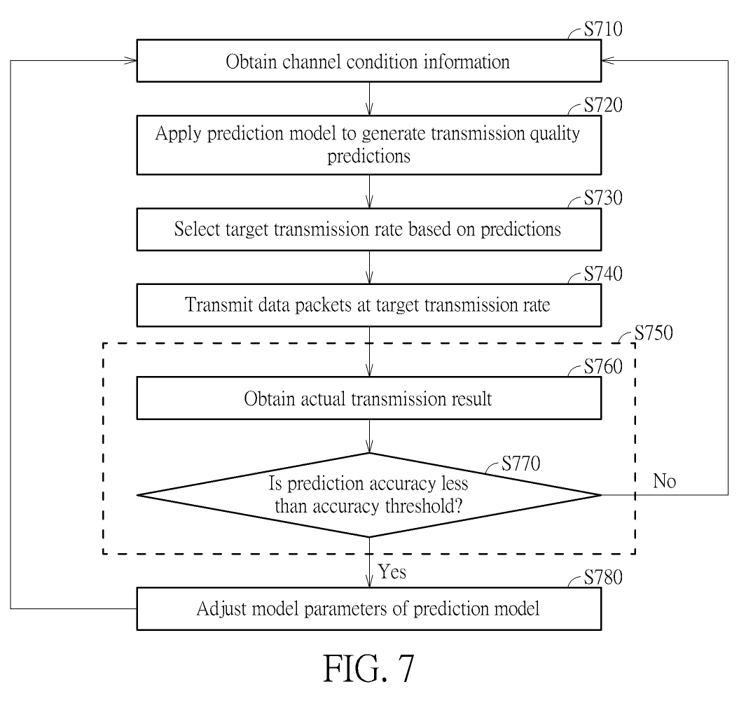

FIG. 7 illustrates a method for wireless communication performed by the wireless communication device 100 according to an embodiment of the present disclosure. The method of FIG. 7 may be performed using the hardware components of FIG. 1 and/or the functional modules of FIG. 6.

At step S710, the wireless communication device 100 obtains the channel condition information Ci associated with the wireless channel 150. The transceiver 130 collects the channel condition information Ci and provides the channel condition information Ci to the processing circuit 120.

At step S720, the processing circuit 120 applies the prediction model 122 to the channel condition information Ci to generate the transmission quality predictions TQpre for the candidate transmission rates Ctr. When the AI ON/OFF module 616 is set to ON, the channel condition information Ci and the candidate transmission rates Ctr are routed to the prediction model 122. The transmission quality predictions TQpre indicate which of the candidate transmission rates Ctr are usable and which are unusable under the current channel conditions, as illustrated in FIG. 2 through FIG. 5.

At step S730, the processing circuit 120 selects the target transmission rate Tr from the candidate transmission rates Ctr based on the transmission quality predictions TQpre generated at step S720. Because the prediction model 122 has already predicted which of the candidate transmission rates Ctr are usable, the processing circuit 120 can select the target transmission rate Tr without transmitting test packets at unusable rates, as illustrated in scenario (B) of FIG. 2 and scenario (D) of FIG. 3.

At step S740, the transceiver 130 transmits one or more data packets 160 at the target transmission rate Tr selected at step S730. After the data packets 160 are transmitted, the method proceeds to step S750.

At step S750, the wireless communication device 100 detects a change in the channel condition information Ci. FIG. 7 shows one way to detect the change: the wireless communication device 100 performs sub-steps S760 and S770. In other implementations, the wireless communication device 100 may detect the change using other indicators, such as a sustained increase in packet error rate or a change in interference conditions.

At sub-step S760, the wireless communication device 100 obtains the actual transmission result At for the data packets 160 transmitted at step S740. The report handler 670 collects the actual transmission result At as part of the TX/RX Statistics 672.

At sub-step S770, the accuracy monitor 652 compares the transmission quality predictions TQpre from step S720 with the actual transmission result At from sub-step S760. Based on this comparison, the accuracy monitor 652 determines a prediction accuracy of the prediction model 122. If the prediction accuracy is at or above the accuracy threshold (the "No" path from sub-step S770), the model parameters 114 do not need to be adjusted, and the method returns to step S710 for the next transmission cycle. If the prediction accuracy is less than the accuracy threshold (the "Yes" path from sub-step S770), the method proceeds to step S780.

At step S780, the processing circuit 120 adjusts the model parameters 114 of the prediction model 122 based on the actual transmission result At obtained at sub-step S760. After the adjustment, the method returns to step S710 for the next transmission cycle.

While specific method steps have been described with reference to FIG. 7, alternative orderings are contemplated. In certain embodiments, certain steps may be performed concurrently, or certain steps may be omitted depending on the deployment configuration of the wireless communication device 100.

FIG. 8 illustrates an off-line learning process for the prediction model 122 according to an embodiment of the present disclosure. In the off-line learning process of FIG. 8, the prediction model 122 is trained using training data collected before the prediction model 122 is deployed on the wireless communication device 100.

As shown in FIG. 8, the prediction model 122 is implemented as a neural network comprising N hidden layers, where N is an integer equal to or greater than three. FIG. 8 shows three hidden layers: a first hidden layer L1, a second hidden layer L2 in FIG. 8, and a third hidden layer LN, where N equals three. In other embodiments, N may be greater than three, and the neural network may include additional hidden layers between the second hidden layer L2 and the N-th hidden layer LN. The first hidden layer L1 receives input data from outside the neural network. The N-th hidden layer LN produces the output of the neural network.

Each hidden layer comprises one or more nodes 116. Each node 116 receives data, performs a computation on the received data, and produces an output. As shown in FIG. 8, each node 116 in a given hidden layer is connected to one or more nodes 116 in an adjacent hidden layer. The connections between the nodes 116 carry the model parameters 114. The model parameters 114 are the weight values that determine how the output of one node 116 is scaled before being provided as input to a node 116 in the next hidden layer. Through these weighted connections, data flows through the neural network from the first hidden layer L1 to the N-th hidden layer LN, and the model parameters 114 control how the neural network transforms the input data into an output.

In FIG. 8, the prediction model 122 is represented by a dashed-dot border that encloses the neural network structure, including all hidden layers and their nodes 116. The prediction model 122 shown in FIG. 8 is consistent with the prediction model 122 described with reference to FIG. 1 and FIG. 6.

The off-line learning process of FIG. 8 uses training data DT to adjust the model parameters 114. The training data DT is composed of two types of input. A first input is a transmission rate TXR. A second input is the channel condition information Ci. The training data DT combines the transmission rate TXR and the channel condition information Ci into a dataset that the neural network uses during the training process to learn the relationship between channel conditions, transmission rates, and transmission quality.

The channel condition information Ci included in the training data DT may include any of the types described with reference to FIG. 1. The specific types of information included in the channel condition information Ci may depend on the capabilities of the wireless communication device 100 and the information available from the transceiver 130. Although specific types of channel condition information have been described with reference to FIG. 1 and FIG. 8, the channel condition information provided to the prediction model 122 is not limited to the listed types. The prediction model 122 may accept any combination of channel condition parameters as input features, and the number and type of input features may vary depending on the capabilities of the transceiver 130 and the specific deployment environment of the wireless communication device 100.

In some implementations, the training data DT is collected in a controlled laboratory environment. The controlled laboratory environment varies at least one of: an interference source, a distance between a transmitter and a receiver, or a variation in antenna gain among a plurality of antennas. By varying these conditions during data collection, the training data DT captures a range of channel scenarios that the wireless communication device 100 may encounter after deployment. For example, the controlled laboratory environment may place the transmitter and the receiver at different distances from each other to simulate near-field and far-field conditions. The controlled laboratory environment may also introduce one or more interference sources at varying power levels to simulate different interference environments. In certain implementations, the controlled laboratory environment may use antennas with different gain values to account for hardware variations among different units of the wireless communication device 100.

During the off-line learning process, the training data DT is fed into the neural network through the nodes 116 in the first hidden layer L1. Each node 116 in the first hidden layer L1 passes processed data to the nodes 116 in the second hidden layer L2, and each subsequent hidden layer processes the data received from a previous hidden layer using the model parameters 114 on the connections between the nodes 116, until the data reaches the nodes 116 in the N-th hidden layer LN. As the training progresses, the model parameters 114 are adjusted iteratively so that the output of the N-th hidden layer LN more closely matches the expected transmission quality for each combination of transmission rate TXR and channel condition information Ci in the training data DT. After the off-line training is complete, the model parameters 114 of the prediction model 122 represent the learned relationship between channel conditions and transmission quality.

After the off-line learning process of FIG. 8 is finished, the prediction model 122 with its trained model parameters 114 is deployed onto the wireless communication device 100. In some implementations, the model parameters 114 are converted into executable code and stored in the memory 110 of the wireless communication device 100. The processing circuit 120 then executes the prediction model 122 using the model parameters 114 stored in the memory 110, as described with reference to FIG. 1.

While the foregoing description has presented the prediction model 122 as a neural network having multiple hidden layers, the prediction model 122 is not limited to any particular neural network architecture. The selection of neural network architecture may depend on the computational resources available in the processing circuit 120 and the latency requirements for rate selection. In some embodiments, the prediction model 122 may comprise a relatively small neural network suitable for deployment on a resource-constrained wireless chipset, with a number of layers and weight parameters selected to enable the processing circuit 120 to complete a forward propagation pass within the time constraints of the rate adaptation process. In other embodiments where the processing circuit 120 has greater computational resources, the prediction model 122 may comprise a larger network with additional hidden layers or additional nodes 116 per layer, potentially achieving higher prediction accuracy at the cost of increased computation.

FIG. 9 illustrates the on-line learning process for the prediction model 122 according to an embodiment of the present disclosure. Unlike the off-line learning process of FIG. 8, which takes place before deployment, the on-line learning process of FIG. 9 takes place after the prediction model 122 has been deployed on the wireless communication device 100. The on-line learning process of FIG. 9 calibrates the prediction model 122 by updating the model parameters 114 based on actual transmission results obtained during operation.

As shown in FIG. 9, the prediction model 122 comprises the same neural network structure as described with reference to FIG. 8. The prediction model 122 receives the candidate transmission rates Ctr and the channel condition information Ci as input.

FIG. 9 illustrates two data paths through the prediction model 122. A first data path is a forward propagation path FP. A second data path is a back propagation path BP.

In the forward propagation path FP, the candidate transmission rates Ctr and the channel condition information Ci are input to the first hidden layer L1 and pass through the hidden layers to the N-th hidden layer LN, which produces the transmission quality predictions for the candidate transmission rates Ctr. Based on the transmission quality predictions, the processing circuit 120 selects the target transmission rate and controls the transceiver 130 to transmit the data packets 160, as described with reference to steps S720 through S740 of FIG. 7.

After the transceiver 130 transmits the data packets 160, the wireless communication device 100 obtains an actual transmission result At. The actual transmission result At indicates whether each transmitted data packet was received successfully by the peer device 180 or failed. As shown in FIG. 9, the actual transmission result At is provided as input to the back propagation path BP of the prediction model 122.

In the back propagation path BP, the processing circuit 120 compares the transmission quality predictions generated during forward propagation with the actual transmission result At. Based on a difference between the transmission quality predictions and the actual transmission result At, the processing circuit 120 computes adjustments to the model parameters 114. The adjustments are propagated backward through the neural network, from the N-th hidden layer LN through the second hidden layer L2 to the first hidden layer L1. Through this back propagation process, the model parameters 114 on the connections between the nodes 116 in each hidden layer are updated so that the prediction model 122 produces more accurate predictions for future transmissions. The back propagation path BP shown in FIG. 9 corresponds to performing back propagation based on the difference between the transmission quality predictions and the actual transmission result to adjust at least one model parameter of the prediction model 122.

The on-line learning process shown in FIG. 9 may be triggered according to different conditions in different implementations. In some implementations, the on-line learning process is triggered when the accuracy monitor 652 determines that the prediction accuracy of the prediction model 122 has fallen below the accuracy threshold, as described with reference to sub-step S770 of FIG. 7 and the accuracy monitor 652 of FIG. 6. In other implementations, the processing circuit 120 may perform the on-line learning process periodically or after each transmission, regardless of the prediction accuracy.

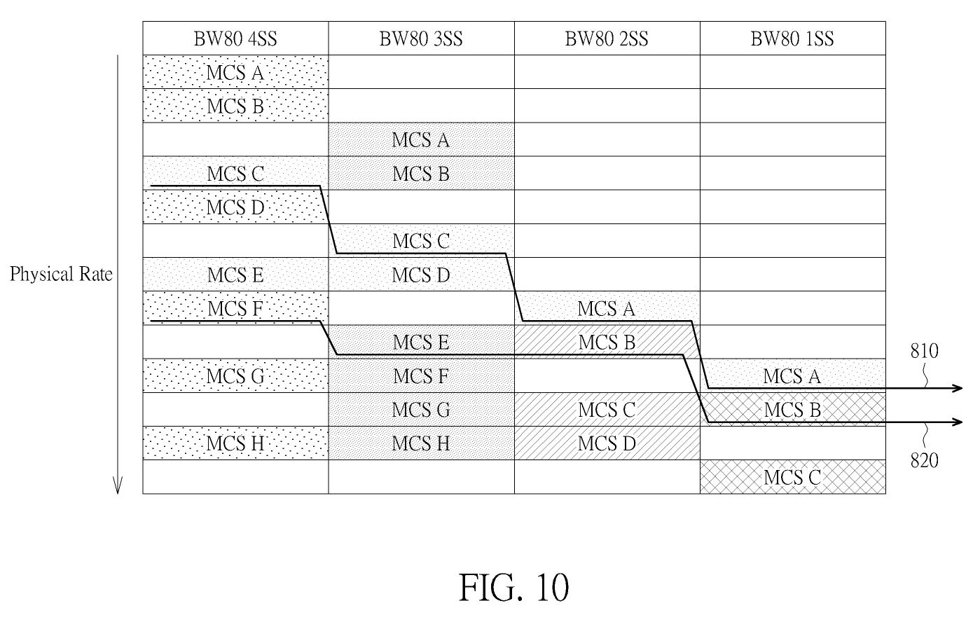

Because the off-line training data DT may not cover all conditions encountered after deployment, such as ambient noise levels, interference patterns, or hardware variations absent from the controlled laboratory environment, the model parameters 114 from the off-line training may produce transmission quality predictions that are higher than what the wireless channel can actually support. The on-line learning process of FIG. 9 adjusts the model parameters 114 based on the actual transmission result At so that the prediction model 122 adapts to the actual operating environment. As a result, the target transmission rate selected after adjustment of the model parameters 114 may differ from the target transmission rate selected prior to the adjustment. In other words, given the same channel condition information Ci as input, the prediction model 122 generates different transmission quality predictions after the model parameters 114 are adjusted than the transmission quality predictions generated prior to the adjustment, and accordingly selects a different target transmission rate. This difference in rate selection under the same channel condition information Ci is an observable indication that the on-line learning process has modified the model parameters 114. This shift is further illustrated with reference to FIG. 10.

While the foregoing description has presented back propagation as the mechanism for on-line learning (FIG. 9), the on-line learning is not limited to updating all of the model parameters 114 in every back propagation pass. In certain embodiments, the processing circuit 120 may adjust only a subset of the model parameters 114 during on-line learning while keeping other model parameters at their current values.

In some embodiments, the on-line learning described with reference to FIG. 9 may be performed at different frequencies depending on the deployment configuration. For example, the processing circuit 120 may perform the back propagation after each transmission, or the processing circuit 120 may perform the back propagation only when the accuracy monitor 652 detects that the prediction accuracy has fallen below the accuracy threshold. The frequency of on-line learning may be selected based on the computational resources of the processing circuit 120 and the rate of change of the wireless channel 150.

In some embodiments, the accuracy threshold used by the accuracy monitor 652 may be a configurable parameter stored in the memory 110.

FIG. 10 illustrates the effect of on-line calibration on the rate selection performed by the prediction model 122 according to an embodiment of the present disclosure. Because the channel condition information may not fully capture the impact of ambient noise on the wireless channel, the transmission quality predictions before on-line calibration may be higher than what the wireless channel can actually support. FIG. 10 shows how, given the same channel condition information Ci, the prediction model 122 selects a different target transmission rate after the on-line learning process of FIG. 9 has adjusted the model parameters 114 than the target transmission rate selected before the adjustment.

FIG. 10 is organized as a table with four columns. Each column represents a different spatial stream configuration at an 80 MHz channel bandwidth: four spatial streams (labeled "BW80 4SS"), three spatial streams (labeled "BW80 3SS"), two spatial streams (labeled "BW80 2SS"), and one spatial stream (labeled "BW80 1SS"). The vertical axis represents the physical rate, with higher physical rates at the top and lower physical rates at the bottom. Within each column, Modulation and Coding Scheme (MCS) rates are arranged from the highest MCS rate at the top to the lowest MCS rate at the bottom. In FIG. 10, the MCS rates are labeled as MCS A, MCS B, MCS C, and so on through MCS H, where MCS A represents the highest MCS rate and MCS H represents the lowest MCS rate within a given column. The specific MCS labels, the number of MCS rates, and the spatial stream configurations shown in FIG. 10 are examples for purposes of illustration.

As described with reference to FIG. 4, a configuration with more spatial streams delivers a wider range of physical rates. Accordingly, the BW80 4SS column has the most MCS rates and the BW80 1SS column has the fewest. Within FIG. 10, the same MCS label in different columns corresponds to the same modulation and coding setting, but the physical rate differs because a configuration with more spatial streams delivers more data per transmission than a configuration with fewer spatial streams. For example, MCS A at BW80 4SS produces a higher physical rate than MCS A at BW80 3SS.

FIG. 10 includes two boundaries that extend across the four columns in a staircase pattern. A first boundary is a rate selection boundary 810 before calibration. A second boundary is a rate selection boundary 820 after calibration. The rate selection boundary 810 represents the highest rate that the prediction model 122 would select for each spatial stream configuration before the on-line calibration of FIG. 9 is performed. The rate selection boundary 820 represents the highest rate that the prediction model 122 would select for each spatial stream configuration after the on-line calibration of FIG. 9 has been performed. In each column, the rate selection boundary 820 is at a lower physical rate than the rate selection boundary 810.

FIG. 10 divides the MCS rates in each column into three regions based on the rate selection boundary 810 and the rate selection boundary 820.

A first region includes rates above the rate selection boundary 810. These rates are unusable under the current ambient noise conditions. The prediction model 122 does not select these rates in either the pre-calibration state or the post-calibration state.

A second region includes rates between the rate selection boundary 810 and the rate selection boundary 820. Before on-line calibration, the prediction model 122 may select a target transmission rate near the rate selection boundary 810, which falls within this second region. These rates appeared usable based on the model parameters 114 that were learned during the off-line training of FIG. 8. However, because the actual operating environment has ambient noise that was not present in the controlled laboratory environment, transmitting data packets 160 at these rates results in a higher packet error rate. After on-line calibration, the prediction model 122 no longer selects rates in this second region because the adjusted model parameters 114 now reflect the actual conditions of the wireless channel.

A third region includes rates at or below the rate selection boundary 820. After on-line calibration, the prediction model 122 selects a target transmission rate near the rate selection boundary 820. These rates are supported by the wireless channel under the current ambient noise conditions, and transmitting the data packets 160 at these rates results in a lower packet error rate than transmitting at the rates in the second region above.

For example, in the BW80 4SS column, the rate selection boundary 810 is at a higher MCS rate than the rate selection boundary 820. Before on-line calibration, the prediction model 122 selects a target transmission rate near the rate selection boundary 810; after calibration, the prediction model 122 selects a target transmission rate near the lower rate selection boundary 820. The MCS rates between the two boundaries are shown with a hatched fill. The same downward shift occurs in each of the BW80 3SS, BW80 2SS, and BW80 1SS columns.

The shift from the rate selection boundary 810 to the rate selection boundary 820 corresponds to a reduced packet error rate after on-line calibration. Because the adjusted model parameters 114 more accurately reflect the actual wireless channel conditions, the packet error rate for the data packets 160 transmitted at the target transmission rate selected after the adjusting is reduced compared to the packet error rate for the data packets 160 transmitted at the target transmission rate selected prior to the adjusting.

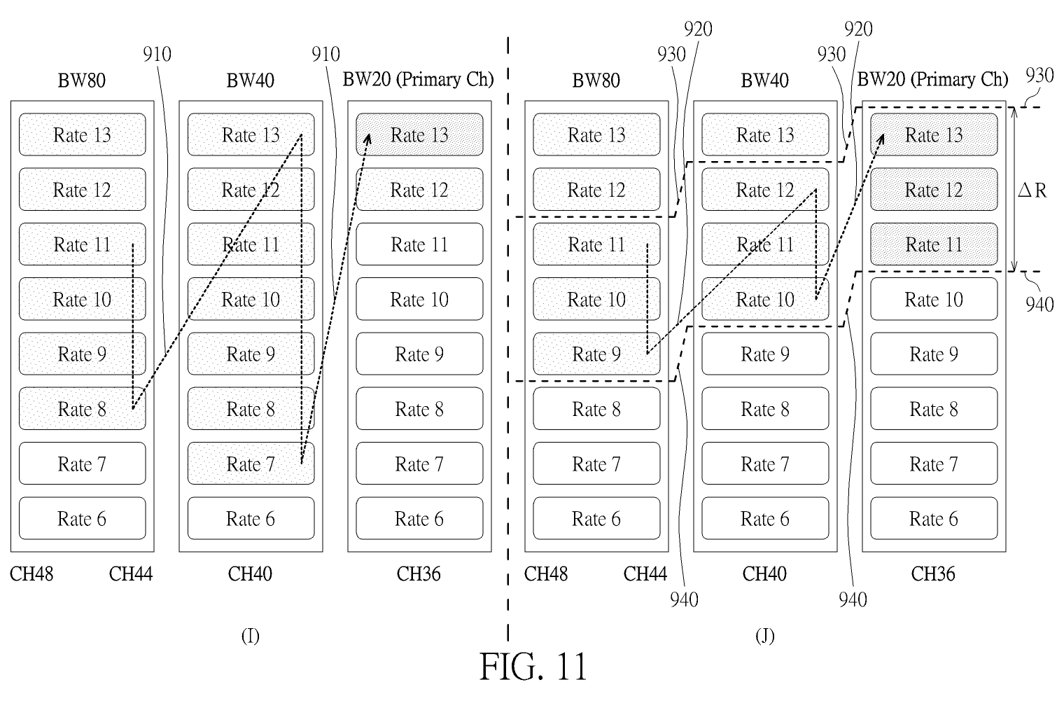

FIG. 11 illustrates a rate down brakes scenario for the wireless communication device 100 according to some implementations of the present disclosure. As with FIG. 2 through FIG. 5, FIG. 11 compares two operational modes side by side: one mode operates without the prediction model 122 (scenario (I)), and the other mode operates with the prediction model 122 enabled (scenario (J)).

FIG. 11 is organized as a table with three columns. Each column represents a different channel bandwidth. A first column is labeled "BW80" and represents an 80 MHz channel bandwidth. A second column is labeled "BW40" and represents a 40 MHz channel bandwidth. A third column is labeled "BW20 (Primary Ch)" and represents a 20 MHz channel bandwidth that corresponds to the primary channel. Below the BW80 column, sub-channel labels CH48 and CH44 are shown to indicate two of the sub-channels within the 80 MHz channel bandwidth. Below the BW40 column, a sub-channel label CH40 is shown. Below the BW20 column, a sub-channel label CH36 is shown. In the example of FIG. 11, interference affects sub-channels CH48, CH44, and CH40, which correspond to the BW80 and BW40 channel bandwidths.

Within each column, eight transmission rate levels are arranged from the highest at the top to the lowest at the bottom: Rate 13, Rate 12, Rate 11, Rate 10, Rate 9, Rate 8, Rate 7, and Rate 6. Higher rate levels correspond to higher data throughput. The specific rate levels, the channel bandwidths, and the sub-channel assignments shown in FIG. 11 are examples for purposes of illustration.

In scenario (I), the wireless communication device 100 operates without the prediction model 122. The interference on sub-channels CH48, CH44, and CH40 causes many rates in the BW80 and BW40 columns to become unusable. However, because the wireless communication device 100 does not have the prediction model 122 to predict which rates are usable at each channel bandwidth, the wireless communication device 100 cannot distinguish usable rates from unusable rates in advance, and does not know how far the rates need to drop before switching to a narrower channel bandwidth.

A try rate path 910 in FIG. 11 illustrates the probing process in scenario (I). The wireless communication device 100 starts at a high rate in the BW80 column and probes lower rates one by one. As the wireless communication device 100 probes down through the BW80 column, the wireless communication device 100 encounters multiple unusable rates. After probing far enough down in the BW80 column, the wireless communication device 100 crosses over to the BW40 column and continues probing. Because the interference also affects sub-channel CH40, the wireless communication device 100 encounters additional unusable rates in the BW40 column. The wireless communication device 100 then crosses over to the BW20 column and continues probing until a usable rate is found. The try rate path 910 is lengthy because the wireless communication device 100 tries many unusable rates in the BW80 and BW40 columns and probes across all three channel bandwidths before settling on a usable rate. Each failed attempt at an unusable rate wastes transmission time without delivering useful data.

In scenario (J), the wireless communication device 100 operates with the prediction model 122 enabled. For each channel bandwidth, the processing circuit 120 applies the prediction model 122 to the channel condition information to determine a predicted maximum usable transmission rate and a reduced transmission rate.

A line 930 in FIG. 11 marks the predicted maximum usable transmission rate for each channel bandwidth. For each column, rates above the line 930 are unusable under the current interference conditions, and rates at or below the line 930 are usable. Because the interference affects the BW80 channel bandwidth more severely than the BW40 channel bandwidth, and the BW40 channel bandwidth more than the BW20 channel bandwidth, the line 930 is at a lower rate level in the BW80 column than in the BW40 column, and at a lower rate level in the BW40 column than in the BW20 column.

A line 940 in FIG. 11 marks the reduced transmission rate for each channel bandwidth. The reduced transmission rate is lower than the predicted maximum usable transmission rate by a predetermined rate offset ΔR. In FIG. 11, the predetermined rate offset ΔR is shown as a double-headed arrow between the line 930 and the line 940 in the BW20 column, and the same predetermined rate offset ΔR applies to each column. For each channel bandwidth, the line 930 and the line 940 define a rate operating range within which the wireless communication device 100 selects a target transmission rate.

A try rate path 920 in FIG. 11 illustrates the rate adaptation in scenario (J). For each channel bandwidth, the processing circuit 120 applies the prediction model 122 to determine the predicted maximum usable transmission rate (the line 930) and the reduced transmission rate (the line 940), and the wireless communication device 100 selects a target transmission rate within the rate operating range defined by the line 930 and the line 940.

When the wireless communication device 100 operates at BW80 and the target transmission rate drops to the reduced transmission rate (the line 940) for BW80, the wireless communication device 100 switches from BW80 to BW40 instead of continuing to probe lower rates. If the target transmission rate for BW40 likewise drops to the reduced transmission rate (the line 940) for BW40, the wireless communication device 100 switches from BW40 to BW20. This cascading bandwidth reduction from BW80 to BW40 to BW20 is shown by the try rate path 920 in FIG. 11. Because BW20 corresponds to the primary channel (CH36), which is not affected by the interference on CH48, CH44, and CH40, the line 930 for BW20 is at a higher rate level than the line 930 for BW80 and BW40.

Accordingly, in scenario (J), the wireless communication device 100 switches to a narrower channel bandwidth when the target transmission rate reaches the reduced transmission rate (the line 940) instead of continuing to probe lower rates, reaching a usable rate with fewer failed transmissions than in scenario (I).

In some embodiments, when the interference condition is no longer present, the wireless communication device 100 may switch from the currently selected channel bandwidth to a wider channel bandwidth by comparing the predicted maximum usable transmission rates, using the same bandwidth comparison mechanism described with reference to FIG. 5.

In the example of FIG. 11, the predetermined rate offset ΔR is the same for each channel bandwidth. In one embodiment, the predetermined rate offset ΔR is three rate levels, as shown in FIG. 11. In some embodiments, the wireless communication device 100 switches to a narrower channel bandwidth when the target transmission rate has been at the reduced transmission rate (the line 940) for a predetermined duration. A shorter predetermined duration causes the wireless communication device 100 to switch to a narrower channel bandwidth more quickly, which may be suitable for rapidly changing interference conditions. A longer predetermined duration causes the wireless communication device 100 to tolerate short-term rate dips before switching, which may be suitable for environments with transient interference.

The disclosed methods and devices provide several technical effects that improve the performance of wireless communication. In one aspect, replacing probe-based rate selection with a prediction model allows the wireless communication device to skip transmission rates that are predicted to be unusable, thereby reducing failed transmissions, shortening the time to reach a stable rate after a channel condition change, and lowering power consumption during rate transitions. In another aspect, the on-line learning process adjusts the model parameters based on actual transmission results so that the prediction model adapts to deployment conditions not covered by the off-line training data, such as ambient noise, hidden node interference, or hardware variations. After the model parameters are adjusted, the prediction model generates different transmission quality predictions for the same channel condition information than the predictions generated prior to the adjustment, resulting in a different target transmission rate and a lower packet error rate after calibration. In yet another aspect, the rate down brakes mechanism defines a rate operating range for each channel bandwidth and triggers a switch to a narrower channel bandwidth when the target transmission rate reaches the lower boundary, rather than continuing to probe unusable rates within the same bandwidth, thereby reducing the latency of bandwidth switching under interference conditions. In a further aspect, the accuracy monitor detects when the prediction accuracy has degraded below an acceptable level and triggers on-line calibration or a temporary fallback to heuristic rate adaptation, maintaining reliable rate selection even when the prediction model encounters unfamiliar channel conditions.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method for wireless communication performed by a wireless communication device, comprising:
obtaining channel condition information associated with a wireless channel;
applying a prediction model to the channel condition information to generate transmission quality predictions for one or more candidate transmission rates;
selecting a target transmission rate from the one or more candidate transmission rates based on the transmission quality predictions; and
transmitting one or more data packets at the target transmission rate.

2. The method of claim 1, further comprising:
bypassing transmission of one or more test packets for one or more transmission rates that are predicted to be unusable by the prediction model.

3. The method of claim 1, further comprising:
determining, using the prediction model, a maximum usable transmission rate for each of a plurality of spatial stream configurations; and
selecting a spatial stream configuration having a highest maximum usable transmission rate among the plurality of spatial stream configurations, thereby avoiding rate probing across the plurality of spatial stream configurations.

4. The method of claim 1, further comprising:
determining, using the prediction model, a maximum usable transmission rate for each of a plurality of channel bandwidths; and
selecting a channel bandwidth from the plurality of channel bandwidths based on a comparison of the maximum usable transmission rates, thereby avoiding rate probing across the plurality of channel bandwidths.

5. The method of claim 1, wherein the channel condition information includes at least one of:
a received signal strength indicator (RSSI);
a signal-to-noise ratio (SNR);
a packet error rate (PER);
an interference indicator;
a distance between the wireless communication device and a peer device; and
traffic information indicating at least one of uplink traffic and downlink traffic.

6. The method of claim 1, wherein the channel condition information includes an angle indicator associated with at least one of:
an antenna orientation;
an angle of arrival (AoA) of a received signal; and
a beamforming direction.

7. The method of claim 1, wherein the prediction model is trained offline prior to deployment on the wireless communication device.

8. The method of claim 7, wherein the prediction model is trained using training data collected in a controlled laboratory environment that varies at least one of:
an interference source;
a distance between transmitter and receiver; and
a variation in antenna gain among a plurality of antennas.

9. The method of claim 1, further comprising:
detecting a change in the channel condition information; and
adjusting at least one model parameter of the prediction model responsive to the change in the channel condition information.

10. The method of claim 1, wherein applying the prediction model comprises:
performing forward propagation to generate the transmission quality predictions; and
wherein the method further comprises:
obtaining an actual transmission result for the one or more data packets; and
performing back propagation based on a difference between the transmission quality predictions and the actual transmission result to adjust at least one model parameter of the prediction model.

11. The method of claim 10, wherein after the at least one model parameter is adjusted, a packet error rate for data packets transmitted at a target transmission rate selected after the at least one model parameter is adjusted is reduced compared to a packet error rate for data packets transmitted at a target transmission rate selected prior to the at least one model parameter being adjusted.

12. A method for wireless communication performed by a wireless communication device, comprising:
obtaining channel condition information associated with a wireless channel for a selected channel bandwidth;
applying a prediction model to the channel condition information to determine a predicted maximum usable transmission rate for the selected channel bandwidth;
determining a reduced transmission rate that is lower than the predicted maximum usable transmission rate by a predetermined rate offset;
selecting a target transmission rate that is less than or equal to the predicted maximum usable transmission rate and greater than or equal to the reduced transmission rate; and
transmitting one or more data packets at the target transmission rate.

13. The method of claim 12, further comprising:
responsive to the target transmission rate being at the reduced transmission rate for a predetermined duration:
applying the prediction model to determine a second predicted maximum usable transmission rate for a second channel bandwidth that is narrower than the selected channel bandwidth; and
switching from the selected channel bandwidth to the second channel bandwidth.

14. The method of claim 13, further comprising:
responsive to a target transmission rate for the second channel bandwidth being at a second reduced transmission rate that is lower than the second predicted maximum usable transmission rate by the predetermined rate offset:
applying the prediction model to determine a third predicted maximum usable transmission rate for a third channel bandwidth that is narrower than the second channel bandwidth; and
switching from the second channel bandwidth to the third channel bandwidth.

15. The method of claim 12, further comprising:
responsive to determining that an interference condition is no longer present, switching from the selected channel bandwidth to a wider channel bandwidth.

16. A wireless communication device, comprising:
at least one processor;
a transceiver; and
a memory storing instructions that, when executed by the at least one processor, cause the wireless communication device to:
obtain channel condition information associated with a wireless channel;
apply a prediction model to the channel condition information to generate transmission quality predictions for one or more candidate transmission rates;
select a target transmission rate from the one or more candidate transmission rates based on the transmission quality predictions; and
control the transceiver to transmit one or more data packets at the target transmission rate.

17. The wireless communication device of claim 16, wherein the instructions further cause the wireless communication device to:
bypass transmission of one or more test packets for one or more transmission rates that are predicted to be unusable by the prediction model.

18. The wireless communication device of claim 16, wherein the instructions further cause the wireless communication device to:
determine, using the prediction model, a maximum usable transmission rate for each of a plurality of spatial stream configurations; and
select a spatial stream configuration having a highest maximum usable transmission rate among the plurality of spatial stream configurations, thereby avoiding rate probing across the plurality of spatial stream configurations.

19. The wireless communication device of claim 16, wherein the instructions further cause the wireless communication device to:
determine, using the prediction model, a maximum usable transmission rate for each of a plurality of channel bandwidths; and
select a channel bandwidth from the plurality of channel bandwidths based on a comparison of the maximum usable transmission rates, thereby avoiding rate probing across the plurality of channel bandwidths.

20. The wireless communication device of claim 16, wherein the prediction model is trained offline prior to deployment on the wireless communication device.

21. The wireless communication device of claim 20, wherein the prediction model is trained using training data collected in a controlled laboratory environment that varies at least one of:
an interference source;
a distance between transmitter and receiver; and
a variation in antenna gain among a plurality of antennas.

22. The wireless communication device of claim 16, wherein the instructions further cause the wireless communication device to:
detect a change in the channel condition information; and
adjust at least one model parameter of the prediction model responsive to the change in the channel condition information.

23. The wireless communication device of claim 22, wherein after the instructions cause the wireless communication device to adjust the at least one model parameter, a packet error rate for data packets transmitted at a target transmission rate selected after the at least one model parameter is adjusted is reduced compared to a packet error rate for data packets transmitted at a target transmission rate selected prior to the at least one model parameter being adjusted.

24. The wireless communication device of claim 22, wherein the instructions cause the wireless communication device to detect the change in the channel condition information by comparing the transmission quality predictions with actual transmission results obtained for the one or more data packets to determine that a prediction accuracy of the prediction model has fallen below an accuracy threshold; and
the instructions cause the wireless communication device to adjust the at least one model parameter responsive to the prediction accuracy having fallen below the accuracy threshold.

25. The wireless communication device of claim 16, wherein:
applying the prediction model comprises performing forward propagation to generate the transmission quality predictions; and
the instructions further cause the wireless communication device to:
obtain an actual transmission result for the one or more
data packets; and
perform back propagation based on a difference between the transmission quality predictions and the actual transmission result to adjust at least one model parameter of the prediction model.

26. A wireless communication device, comprising:
at least one processor;
a transceiver; and
a memory storing instructions that, when executed by the at least one processor, cause the wireless communication device to: obtain channel condition information associated with a wireless channel for a selected channel bandwidth;
apply a prediction model to the channel condition information to determine a predicted maximum usable transmission rate for the selected channel bandwidth;
determine a reduced transmission rate that is lower than the predicted maximum usable transmission rate by a predetermined rate offset;
select a target transmission rate that is less than or equal to the predicted maximum usable transmission rate and greater than or equal to the reduced transmission rate; and
control the transceiver to transmit one or more data packets at the target transmission rate.

27. The wireless communication device of claim 26, wherein the instructions further cause the wireless communication device to:
responsive to the target transmission rate being at the reduced transmission rate for a predetermined duration:
apply the prediction model to determine a second predicted maximum usable transmission rate for a second channel bandwidth that is narrower than the selected channel bandwidth; and
switch from the selected channel bandwidth to the second channel bandwidth.

28. The wireless communication device of claim 27, wherein the instructions further cause the wireless communication device to:
responsive to a target transmission rate for the second channel bandwidth being at a second reduced transmission rate that is lower than the second predicted maximum usable transmission rate by the predetermined rate offset:
apply the prediction model to determine a third predicted maximum usable transmission rate for a third channel bandwidth that is narrower than the second channel bandwidth; and
switch from the second channel bandwidth to the third channel bandwidth.
